(19) United States
(12) Patent Application Publication
(10) Pub. No.: US 2018/0334269 A1
(43) Pub. Date: Nov. 22, 2018

(54) THERMAL EMISSION STRUCTURE

(71) Applicant: Toyota Jidosha Kabushiki Kaisha, Toyota-shi Aichi-ken (JP)

(72) Inventors: Hiroshi Yoshimoto, Toyota-shi Aichi (JP); Toshio Watari, Nagoya-shi Aichi (JP); Kota Ito, Nagakute-shi Aichi (JP); Hideo Iizuka, Nagakute-shi Aichi (JP)

(21) Appl. No.: 15/982,333

(22) Filed: May 17, 2018

(30) Foreign Application Priority Data
May 19, 2017 (JP) 2017-099548
Jan. 19, 2018 (JP) 2018-007431

(51) Int. Cl. B64G 1/50; B64G 1/22; C01G 31/02; C01G 45/12; C09K 5/14; F28F 21/00

(52) U.S. Cl. CPC B64G 1/503; B64G 1/226; C01G 31/02; B32B 3/30; C09K 5/14; F28F 21/00; C01G 45/1264

(57) ABSTRACT

A thermal emission structure capable of exhibiting heat release characteristics reverse to those of a Phase-change material used therein includes a first conductor layer, a dielectric layer on the first conductor layer, and a second conductor layer on the dielectric layer and having a periodic geometry, at least one of the first conductor layer and the second conductor layer comprises a Phase-change material having an electrical conduction property that varies between a high-temperature phase and a low-temperature phase.

### CROSS REFERENCE TO RELATED APPLICATIONS

The present application claims priority from Japanese patent application JP 2017-099548 filed on May 19, 2017, and Japanese patent application JP 2018-007431 filed on Jan. 19, 2018, the contents of which are hereby incorporated by reference into this application.

### BACKGROUND

### Technical Field

This disclosure generally relate to a thermal emission structure capable of emitting heat.

### Background Art

Electronic equipment including electronic components is desired to maintain its temperature within an appropriate range from the viewpoint of the performance and service life of the electronic components. Thus, making a contribution to increasing the efficiency of various industrial machines by thermal management can give a very great impact, for example, on environmental countermeasures such as CO₂ emission reduction. Among three modes (conduction, convection, and radiation) of heat transfer, thermal radiation has high controllability. Thus, for control of the temperature of electronic equipment, thermal control devices capable of controlling the temperature by exploiting thermal radiation (thermal emission) within the equipment have been developed.

For example, JP Patent Publication (Kokai) No. 11-217562 A discloses a thermal control device characterized by controlling the temperature of an object using a Phase-change material that assumes the nature of an insulator in a high-temperature phase and the nature of a metal in a low-temperature phase and that emits a large amount of heat in the high-temperature phase and a small amount of heat in the low-temperature phase. The thermal control device is mounted on an object such as a satellite or spaceship. In the case of this thermal control device, when the temperature of the object rises to or above the Phase-transition temperature of the Phase-change material, the thermal emittance of the Phase-change material increases, so that the amount of heat released to the outside environment is increased. This results in a drop in the temperature of the object. On the other hand, when the temperature of the object drops to or below the Phase-transition temperature of the Phase-change material, the emittance of the Phase-change material decreases, so that the amount of released heat is reduced. This results in a rise in the temperature of the object. With the thermal control device, therefore, the temperature of the object can automatically be controlled to around the Phase-transition temperature. JP Patent Publication (Kokai) No. 11-217562 A mentions perovskite Mn oxides and corundum vanadium oxides as examples of the “Phase-change material that assumes the nature of an insulator in a high-temperature phase and the nature of a metal in a low-temperature phase and that emits a large amount of heat in the high-temperature phase and a small amount of heat in the low-temperature phase”.

JP Patent Publication (Kokai) No. 2002-120799 A discloses a thermal control device characterized by controlling the temperature of an object using a composite material consisting of a combination of a substrate substance that emits a large amount of heat in a high-temperature phase and a Phase-change material that assumes the nature of an insulator in a high-temperature phase and the nature of a metal in a low-temperature phase, that emits a large amount of heat in the high-temperature phase and a small amount of heat in the low-temperature phase, and that in the low-temperature phase exhibits a high reflectance in the thermal infrared region. The disclosure of JP Patent Publication (Kokai) No. 2002-120799 A corresponds to an improvement of the disclosure of JP Patent Publication (Kokai) No. 11-217562 A mentioned above and can, like the disclosure of JP Patent Publication (Kokai) No. 11-217562 A, increase the amount of heat released to the outside environment when the temperature of the object is high and reduce the amount of heat released to the outside environment when the temperature of the object is low.

JP Patent Publication (Kokai) No. 1-212699 A discloses a thermal control device for a satellite, the thermal control device being characterized in that a Phase-change material that exhibits a low infrared radiance at a range of temperatures higher than a transition temperature at which phase transition occurs and that exhibits a high infrared radiance at a range of temperatures lower than the transition temperature is disposed on the surface of a heat sink that undergoes radiant heat exchange with on-board equipment. In the thermal control device of JP Patent Publication (Kokai) No. 1-212699 A, vanadium dioxide is used as the Phase-change material. The thermal control device is disposed between the on-board equipment requiring temperature control and the heat sink and prevents heat from being transmitted to the on-board equipment from the heat sink made hot by external thermal input such as that from sunlight. Specifically, when no sunlight enters the heat sink and the temperature of the thermal control device is lower than the transition temperature of vanadium dioxide, heat from the on-board equipment is efficiently delivered to the heat sink and emitted to outer space from the heat sink. On the other hand, when sunlight enters the heat sink to heat the thermal control device so that the temperature of the thermal control device rises beyond the transition temperature of vanadium dioxide, heat transmission from the heat sink to the on-board equipment is reduced to prevent heating of the on-board equipment.

### SUMMARY

As is known from Patent Literatures mentioned above, thermal control devices have been disclosed which are capable of controlling the heat of an object requiring control of heat by using a Phase-change material, specifically by exploiting the difference in the nature of the Phase-change material between a high-temperature phase and a low-temperature phase.

However, for a thermal control device, such as that of the disclosure of JP Patent Publication (Kokai) No. 11-217562 A or JP Patent Publication (Kokai) No. 2002-120799 A, which increases the amount of heat released to the outside environment upon a rise in temperature of an object and reduces the amount of heat released to the outside environment upon a drop in temperature of the object, the Phase-change material used is required to be a Phase-change material that emits a large amount of heat in a high-temperature phase and emits a small amount of heat in a low-temperature phase. Namely, when a thermal control device is required to have the property of releasing more heat at high temperatures and releasing less heat at low temperatures, the Phase-change material used in the thermal control device naturally needs to release more heat (exhibit a high heat release rate) in a high-temperature phase and release less heat (exhibit a low heat release rate) in a low-temperature phase.

Additionally, for a thermal control device, such as that of the disclosure of JP Patent Publication (Kokai) No. 1-212699 A, which reduces heat transmission to an object from a heat sink made hot by external thermal input and which allows heat within the object to be efficiently delivered to the heat sink when the temperature of the heat sink is low, the Phase-change material used is required to be a “Phase-change material that exhibits a low infrared radiance at a range of temperatures higher than a transition temperature at which phase transition occurs and that exhibits a high infrared radiance at a range of temperatures lower than the transition temperature”. Namely, when a thermal control device is required to have the property of releasing less heat at high temperatures and releasing more heat at low temperatures, the Phase-change material used in the thermal control device naturally needs to release less heat (exhibit a low heat release rate) in a high-temperature phase and release more heat (exhibit a high release rate) in a low-temperature phase.

As described above, the heat release characteristics of a thermal control device correlate to the heat release characteristics of the Phase-change material used therein and, therefore, what Phase-change material should be used is naturally determined depending on the characteristics required of the thermal control device.

If heat release characteristics different from those of a Phase-change material used in a thermal control device can be achieved by the structure of the thermal control device, then the variety of materials selectable as the Phase-change material will be increased to provide a great benefit.

That is, Phase-change materials each have a specific Phase-transition temperature or specific thermal emission characteristics depending on their material composition, and only limited types of Phase-change materials have both a required Phase-transition temperature and required thermal emission characteristics. Specifically, for example, the following literatures demonstrate that the use of phase transition of vanadium dioxide allows controlling the radiant heat flow with high contrast: K. Ito, K. Nishikawa, H. Iizuka, H. Toshiyoshi, “Experimental investigation of radiative thermal rectifier using vanadium dioxide,” Applied Physics Letters 105, No. 25, 253503 (2014); and M. Kats, R. Blanchard, S. Zhang, P. Genevet, C. Ko, S. Ramanathan, and F. Capasso. “Vanadium dioxide as a natural disordered metamaterial: perfect thermal emission and large broadband negative differential thermal emittance.” Physical Review X 3, No. 4, 041004 (2013). It may thus be conceivable to attach vanadium dioxide to equipment as an object whose temperature is to be kept constant and thereby control heat release from the object. However, when the equipment as the object is required to be endowed with the property of releasing less heat at low temperatures and releasing more heat at high temperatures, the use of vanadium dioxide results in the endowment of the equipment with a property opposite to the required property because vanadium dioxide releases more heat in a low-temperature phase and releases less heat in a high-temperature phase. Thus, if heat release characteristics reverse to those of the Phase-change material used can be achieved by a structure, then the variety of materials selectable as the Phase-change material will be increased. The development of such technology has thus been demanded.

Therefore, this disclosure relate to providing a thermal emission structure capable of exhibiting heat release characteristics reverse to those of a Phase-change material used therein.

Exemplary embodiments are as follows.

(1) A thermal emission structure capable of thermal emission, comprising: a first conductor layer; a dielectric layer on the first conductor layer; and a second conductor layer on the dielectric layer and having a periodic geometry, wherein at least one of the first conductor layer and the second conductor layer comprises a Phase-change material having an electrical conduction property that varies between a high-temperature phase and a low-temperature phase.

(2) The thermal emission structure according to (1), wherein the first conductor layer comprises a non-Phase-change material, and the second conductor layer comprises the Phase-change material.

(3) The thermal emission structure according to (1), wherein the first conductor layer comprises the Phase-change material, and the second conductor layer comprises a non-Phase-change material.

(4) The thermal emission structure according to (1), wherein both the first conductor layer and the second conductor layer comprise the Phase-change material.

(5) The thermal emission structure according to any one of (1) to (4), wherein the Phase-change material is a material that has a higher electrical conductivity in the high-temperature phase than in the low-temperature phase and that has a lower thermal emittance in the high-temperature phase than in the low-temperature phase.

(6) The thermal emission structure according to (5), wherein the Phase-change material is a vanadium oxide.

(7) The thermal emission structure according to any one of (1) to (4), wherein the Phase-change material is a material that has a lower electrical conductivity in the high-temperature phase than in the low-temperature phase and that has a higher thermal emittance in the high-temperature phase than in the low-temperature phase.

(8) The thermal emission structure according to (7), wherein the Phase-change material is a perovskite Mn oxide.

(9) The thermal emission structure according to any one of (1) to (8), having a thermal emittance that varies according to temperature.

(10) A heater comprising a heat generator that generates heat and the thermal emission structure according to any one of (1) to (9) that serves as a thermal emission device that emits the heat.

(11) A thermal control system comprising an object and the thermal emission structure according to any one of (1) to (9) that serves as a thermal control device that controls heat of the object.

(12) A method of controlling heat of an object by providing the thermal emission structure according to any one of (1) to (9) inside or outside the object.

According to this disclosure, it is possible to provide a thermal emission structure capable of exhibiting heat release characteristics reverse to those of the Phase-change material used therein.

### BRIEF DESCRIPTION OF THE DRAWINGS

FIG. 1 is a schematic cross-sectional view for illustrating the configuration of a thermal emission structure 10 according to the exemplary embodiments;

FIG. 2 is a schematic perspective view of the thermal emission structure of FIG. 1;

FIG. 3 is a schematic perspective view for illustrating an example of the dimensions of the thermal emission structure (one cell) of FIG. 1;

FIG. 4 is a schematic cross-sectional view for illustrating the configuration of a thermal emission structure 20 according to the exemplary embodiments;

FIG. 5 is a schematic perspective view of the thermal emission structure of FIG. 4;

FIG. 6 is a schematic perspective view for illustrating an example of the dimensions of the thermal emission structure (one cell) of FIG. 4;

FIG. 7A is a schematic cross-sectional view for illustrating the configuration of a thermal emission structure 100;

FIG. 7B is a schematic cross-sectional view for illustrating the configuration of a thermal emission structure 110;

FIG. 8 is a schematic cross-sectional view for illustrating the configuration of a thermal emission structure 120;

FIG. 9 is a schematic cross-sectional view for illustrating the configuration of a thermal emission structure 130;

FIG. 10A is a schematic cross-sectional view for illustrating the configuration of a thermal emission structure 200;

FIG. 10B is a schematic cross-sectional view for illustrating the configuration of a thermal emission structure 210;

FIG. 11 is a schematic cross-sectional view for illustrating the configuration of a heater 1000 according to Embodiment 7;

FIG. 12 is a schematic cross-sectional view for illustrating an example of the configuration of a thermal control system 2000 including a thermal control device according to Embodiment 8;

FIG. 13A shows the result of analysis conducted for the emission characteristics of the thermal emission structure 100 using a dielectric constant determined by assuming that the second conductor layer 102 (vanadium dioxide) is in a high-temperature phase (345 K);

FIG. 13B shows the result of analysis conducted for the emission characteristics of the thermal emission structure 100 using a dielectric constant determined by assuming that the second conductor layer 102 (vanadium dioxide) is in a low-temperature phase (335 K);

FIG. 14A shows the result of analysis conducted for the emission characteristics of the thermal emission structure 110 using a dielectric constant determined by assuming that the second conductor layer 102 (vanadium dioxide) is in a high-temperature phase (345 K);

FIG. 14B shows the result of analysis conducted for the emission characteristics of the thermal emission structure 110 using a dielectric constant determined by assuming that the second conductor layer 102 (vanadium dioxide) is in a low-temperature phase (335 K);

FIG. 15A shows the result of analysis conducted for the emission characteristics of the thermal emission structure 120 using a dielectric constant determined by assuming that the first conductor layer 121 (vanadium dioxide) is in a high-temperature phase (345 K);

FIG. 15B shows the result of analysis conducted for the emission characteristics of the thermal emission structure 120 using a dielectric constant determined by assuming that the first conductor layer 121 (vanadium dioxide) is in a low-temperature phase (335 K);

FIG. 16 is a graph showing the simulation results (absorption spectra) in Example 4;

FIG. 17 is a SEM image of a thermal emission structure 100 produced in Example 5;

FIG. 18 is a graph showing the results of absorption spectrum measurement for the thermal emission structure 100 produced in Example 5;

FIG. 19 is a graph showing the absorption spectra shown in FIG. 16 which were obtained by simulation and the absorption spectra shown in FIG. 18 which were obtained for the actually produced thermal emission structure 100;

FIG. 20 is a graph showing the simulation results (absorption spectra) in Example 6;

FIG. 21 is a SEM image of a thermal emission structure 100 produced in Example 7;

FIG. 22 is a graph showing the results of absorption spectrum measurement for the thermal emission structure 100 produced in Example 7; and

FIG. 23 is a graph showing the absorption spectra shown in FIG. 20 which were obtained by simulation and the absorption spectra shown in FIG. 22 which were obtained for the actually produced thermal emission structure 100.

### DETAILED DESCRIPTION

As described above, the exemplary embodiments relate to a thermal emission structure capable of thermal emission, comprising a first conductor layer, a dielectric layer on the first conductor layer, and a second conductor layer on the dielectric layer and having a periodic geometry, at least one of the first conductor layer and the second conductor layer comprises a Phase-change material having an electrical conduction property that varies between a high-temperature phase and a low-temperature phase.

According to the exemplary embodiments, heat release characteristics reverse to those of the Phase-change material used can be achieved. Specifically, when the Phase-change material used has such heat release characteristics that it releases less heat in a high-temperature phase and releases more heat in a low-temperature phase (namely, when the heat release rate is low in the high-temperature phase and high in the low-temperature phase), the thermal emission structure according to the exemplary embodiments exhibits such heat release characteristics that it releases more heat at high temperatures and releases less heat at low temperatures (namely, the heat release rate is high at high temperatures and low in the low-temperature phase). On the other hand, when the Phase-change material used has such heat release characteristics that it releases more heat in a high-temperature phase and releases less heat in a low-temperature phase (namely, when the heat release rate is high in the high-temperature phase and low in the low-temperature phase), the thermal emission structure according to the exemplary embodiments exhibits such heat release characteristics that it releases less heat at high temperatures and releases more heat at low temperatures (namely, the heat release rate is low at high temperatures and high in the low-temperatures).

According to the exemplary embodiments, a structure having a novel configuration and capable of emitting or controlling heat can be provided. The configuration can enlarge the range of choices of usable Phase-change materials.

Hereinafter, the exemplary embodiments will be described in detail with reference to the drawings.

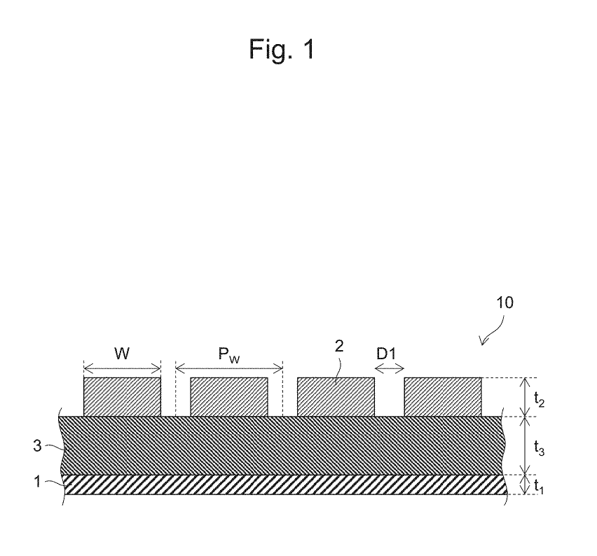

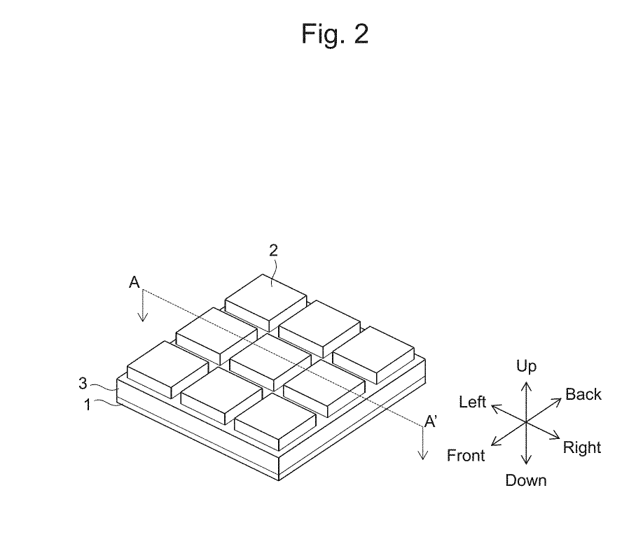

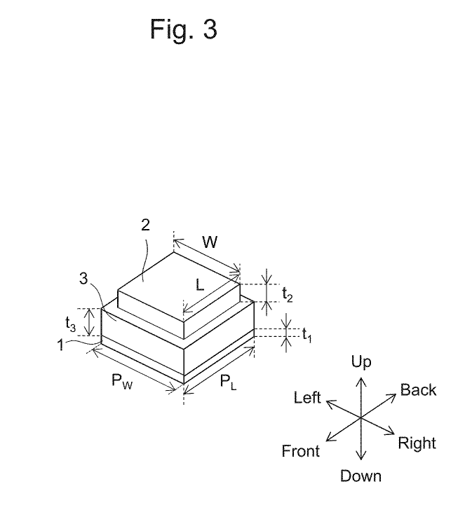

FIG. 1 is a schematic cross-sectional view for illustrating the configuration of a thermal emission structure according to the exemplary embodiments. FIG. 2 is a schematic perspective view of the thermal emission structure of FIG. 1. FIG. 3 is a schematic perspective view for illustrating an example of the dimensions of the thermal emission structure (one cell) of FIG. 1. FIG. 1 corresponds to a cross-sectional view of a thermal emission structure 10 of FIG. 2 taken along the dotted line AA′ in the direction of the arrow. In the exemplary embodiments, the right-left direction, the front-back direction, and the up-down direction are as indicated in FIG. 2 or 3. The thermal emission structure 10 comprises a first conductor layer 1, a dielectric layer 3 provided on the first conductor layer 1, and a second conductor layer 2 provided on the dielectric layer 3 and having a periodic geometry. At least one of the first conductor layer 1 and the second conductor layer 2 is composed of a Phase-change material having an electrical conduction property that varies between a high-temperature phase and a low-temperature phase. This thermal emission structure 10 serves as a metamaterial emitter as a function of temperature and is capable of emitting heat in the upward direction as indicated in FIG. 1. Namely, the thermal emittance of the thermal emission structure 10 varies according to temperature. The thermal emission structure 10 can therefore be used, for example, as a thermal control device for controlling heat of an object or as a thermal emission device that emits heat used by a heater for heating an object.

The first conductor layer 1 is composed of a conductor (electrical conductor). The term “conductor” as used herein encompasses Phase-change materials. Phase-change materials have a high electrical conduction property either in a high-temperature phase or in a low-temperature phase and can therefore be considered conductors.

Examples of conductive materials (non-Phase-change materials) which are not Phase-change materials include metals, and specific examples of the metals include gold (Au), aluminum (Al), tungsten (W), and tantalum (Ta).

The dielectric layer 3 is sandwiched between the first conductor layer 1 and the second conductor layer 2. Examples of the material of the dielectric layer 3 include amorphous silicon, alumina (Al₂O₃), and silica (SiO₂).

The second conductor layer 2, like the first conductor layer 1, is composed of a conductor. The material of the first conductor layer and the material of the second conductor layer may each be independently selected. The second conductor layer 2 has a plurality of separate conductor layers.

Possible embodiments of the thermal emission structure include an embodiment in which both the first conductor layer 1 and the second conductor layer 2 are composed of a Phase-change material, an embodiment in which the first conductor layer 1 is composed of a Phase-change material while the second conductor layer 2 is composed of a non-Phase-change material, and an embodiment in which the first conductor layer 1 is composed of a non-Phase-change material while the second conductor layer 2 is composed of a Phase-change material.

An adhesive layer may be provided between the second conductor layer 2 and the dielectric layer 3. An adhesive layer may be provided also between the dielectric layer 3 and the first conductor layer 1. Using an adhesive layer can enhance the interlayer adhesion as compared to bonding the layers directly to one another. Examples of the material of the adhesive layer include chromium (Cr), titanium (Ti), and ruthenium (Ru).

In the exemplary embodiments, at least one of the first conductor layer and the second conductor layer is composed of a Phase-change material having an electrical conduction property that varies between a high-temperature phase and a low-temperature phase. Any material having an electrical conduction property that varies between a high-temperature phase and a low-temperature phase can be used as the Phase-change material without particular limitation.

An exemplary material that can be used as the Phase-change material is a material that has a higher electrical conductivity in a high-temperature phase than in a low-temperature phase and that has a lower thermal emittance in the high-temperature phase than in the low-temperature phase (more particularly a material that has a metal-like nature in a high-temperature phase and has an insulator-like nature in a low-temperature phase and that exhibits a low thermal emittance in the high-temperature phase and exhibits a high thermal emittance in the low-temperature phase). Examples of such a Phase-change material include vanadium oxides. Examples of the vanadium oxides include vanadium dioxide and an oxide derived by substitution of part of vanadium in the vanadium dioxide with other metal(s) (for example, a transition metal such as tungsten). In general, vanadium dioxide has a Phase-transition temperature around 70° C. (343 K).

Another exemplary material that can be used as the Phase-change material is a material that has a lower electrical conductivity in a high-temperature phase than in a low-temperature phase and that has a higher thermal emittance in the high-temperature phase than in the low-temperature phase (more particularly a material that has an insulator-like nature in a high-temperature phase and has a metal-like nature in a low-temperature phase and that exhibits a high thermal emittance in the high-temperature phase and exhibits a low thermal emittance in the low-temperature phase). Examples of such a Phase-change material include perovskite Mn oxides. Examples of the perovskite Mn oxides include a Mn-containing perovskite oxide represented by A₁₋ₓBₓMnO₃ wherein A denotes at least one rare-earth metal selected from La, Pr, Nd, and Sm, and B denotes at least one alkaline-earth metal selected from Ca, Sr, and Ba. In general, perovskite Mn oxides have a Phase-transition temperature around −23° C. (250 K). Examples other than perovskite Mn oxides include Cr-containing corundum vanadium oxides, specific examples of which include a corundum vanadium oxide represented by (V₁₋ₓCrₓ)₂O₃.

The term “Phase-change material” as used herein refers to a material that undergoes phase transition depending on temperature to change its radiance and electrical conductivity. A Phase-change material can be termed “phase change material”. In some embodiments, the resistance value of the Phase-change material in a high-temperature phase and the resistance value of the Phase-change material in a low-temperature phase differ by three or more orders of magnitude. In some embodiments, the resistance value at a temperature 50° C. above the Phase-transition temperature and the resistance value at a temperature 50° C. below the Phase-transition temperature differ by three or more orders of magnitude, and in some embodiments, the resistance value at a temperature 30° C. above the Phase-transition temperature and the resistance value at a temperature 30° C. below the Phase-transition temperature differ by three or more orders of magnitude. The Phase-transition temperature Tc can be defined, for example, as such a temperature that a logarithm of the resistance value at Tc is equal to the average of logarithms of the resistance values in the temperature range of Tc±50° C. When the phase transition exhibits a temperature hysteresis, the Phase-transition temperature can be defined as the average of Tc during heating and Tc during cooling.

The second conductor layer 2 has a periodic geometry. Specifically, the second conductor layer 2 comprises a plurality of separate conductor layers, and these separate conductor layers are spaced from each other in directions along the emission surface so that the periodic geometry can be formed. In FIGS. 1 to 3, separate conductor layers in the shape of a rectangular parallelepiped are disclosed. However, the exemplary embodiments are not limited to such a shape, and the separate conductor layers may have any of various shapes such as a linear shape, cross shape, and disc shape. The shape of the separate conductor layers can be adjusted depending on the desired emission wavelength.

In the exemplary embodiments, the separate conductor layers are arranged in the right-left direction (first direction) at regular distances D1 from each other (see FIG. 1). The separate conductor layers are arranged in the front-back direction (second direction) orthogonal to the right-left direction at regular distances D2 (not illustrated) from each other. Thus, the separate conductor layers are arranged in a grid pattern. Each of the separate conductor layers is in the shape of a rectangular parallelepiped in which the thickness t₂ (height in the up-down direction) is smaller than the width W (size in the right-left direction) and the length L (size in the front-back direction). As for the period of the periodic geometry of the second conductor layer 2, the period in the width direction is expressed as Λ1=D1+W (P_{W}) and the period in the length direction is expressed as Λ2=D2+L (P_{L}).

The thickness (t₁) of the first conductor layer 1, the thickness (t₂) of the second conductor layer 2, and the thickness (t₃) of the dielectric layer 3 are not particularly limited and can each be selected as appropriate. The thickness (t₁) of the first conductor layer 1 is, for example, 30 to 300 nm. The thickness (t₂) of the second conductor layer 2 is, for example, 30 to 300 nm. The thickness (t₃) of the dielectric layer 3 is, for example 50 to 500 nm.

The materials, shape, and periodic geometry described above can be adjusted so that the thermal emission structure 10 has the property of emitting infrared rays at a desired wavelength from the emission surface. As for the shape of each separate conductor layer, the width W can be, for example, 500 nm or more and 3000 nm or less. The length L can be, for example, 500 nm or more and 3000 nm or less. The thickness t₂ can be, for example, 30 nm or more and 300 nm or less. As for the periodic geometry of the second conductor layer 2, the distance D1 in the right-left direction can be, for example, 100 nm or more and 3000 nm or less. The distance D2 in the front-back direction can be, for example, 100 nm or more and 3000 nm or less. The width W and the length L may be the same or different. The same applies to the distance D1 and distance D2 and to the period Λ1 and period Λ2.

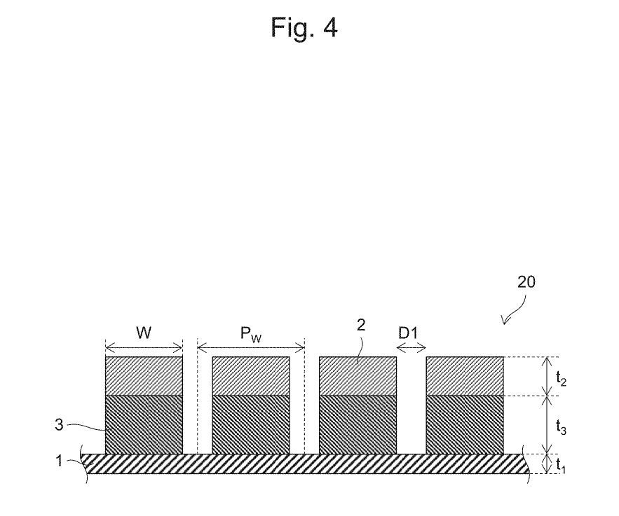

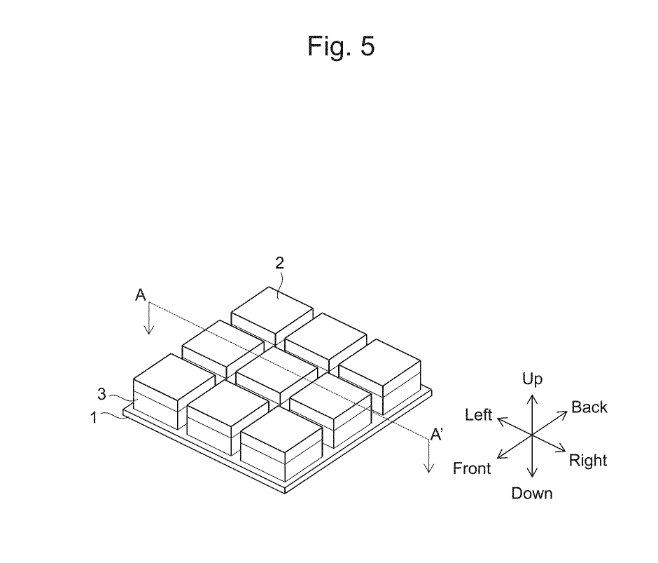

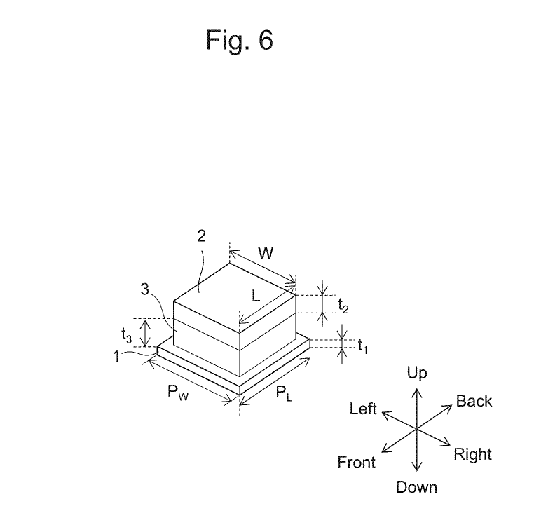

FIGS. 1 to 3 show an embodiment in which the dielectric layer 3, like the first conductor layer 1, is in the form of a flat plate. The shape of the dielectric layer 3 is not limited to that in this embodiment; for example, the dielectric layer 3 may have a periodic geometry so as to conform to the second conductor layer 2. For a thermal emission structure 20 in which the dielectric layer 3 has a periodic geometry so as to conform to the second conductor layer 2, an exemplary configuration is shown in FIGS. 4 to 6. FIG. 4 is a schematic cross-sectional view for illustrating the configuration of the thermal emission structure 20, FIG. 5 is a schematic perspective view of the thermal emission structure of FIG. 4, and FIG. 6 is a schematic perspective view for illustrating an example of the dimensions of the thermal emission structure (one cell) of FIG. 4.

Hereinafter, more specific embodiments will be described with reference to the drawings.

### Embodiment 1

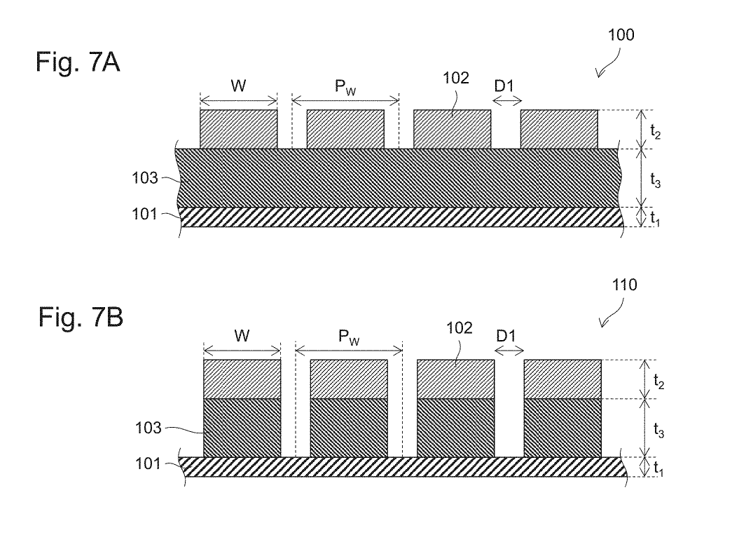

For Embodiment 1, a description is given with reference to FIGS. 7A and 7B.

In Embodiment 1, a thermal emission structure 100 is described in which the first conductor layer is composed of a conductive material (non-Phase-change material: metal) which is not a Phase-change material and the second conductor layer is composed of a Phase-change material (vanadium dioxide which is a material that has a higher electrical conductivity in a high-temperature phase than in a low-temperature phase and that has a lower thermal emittance in the high-temperature phase than in the low-temperature phase).

The first conductor layer 101 is a flat plate-shaped member made of a metal (Al, for example).

The dielectric layer 103 is a flat plate-shaped member provided on the first conductor layer 101 and composed of a dielectric material (amorphous silicon, for example). The dielectric layer 103 is sandwiched between the first conductor layer 101 and the second conductor layer 102. FIG. 7A shows the dielectric layer 103 in the shape of a flat plate; however, the dielectric layer may have a periodic geometry conforming to the periodic geometry of the second conductor layer 102 as in a thermal emission structure 110 shown in FIG. 7B.

As mentioned above, the second conductor layer 102 (separate conductor layers) is composed of vanadium dioxide. Vanadium dioxide is a Phase-change material whose resistance value varies by three or more orders of magnitude at around about 340 K. Vanadium dioxide is a Phase-change material that has a metal-like nature in a high-temperature phase and has an insulator-like nature in a low-temperature phase and that exhibits a low thermal emittance in the high-temperature phase and exhibits a high thermal emittance in the low-temperature phase. The Phase-transition temperature of vanadium dioxide can be lowered, for example, by partial substitution of vanadium with tungsten (V₁₋ₓWₓO₂).

The following will describe the mechanism by which the thermal emission structure according to the exemplary embodiment can exhibit heat release characteristics reverse to those of the Phase-change material used therein.

First, a description is given of the situation where the temperature of the thermal emission structure 100 is high, namely where the thermal emission structure 100 has a temperature (345 K, for example) higher than the Phase-transition temperature of vanadium dioxide. As stated above, the thermal emission structure 100 comprises the second conductor layer 102 (Phase-change material: vanadium dioxide) having a periodic geometry, the first conductor layer 101 (non-Phase-change material: Al, for example), and the dielectric layer 103 (amorphous silicon, for example) sandwiched between the second conductor layer 102 and first conductor layer 101. When the temperature of the thermal emission structure 100 is high, the second conductor layer 102 composed of vanadium dioxide exhibits an electrical conduction property, which means that the thermal emission structure 100 has a configuration in which a dielectric layer is sandwiched between two conductor layers. Thus, the thermal emission structure 100 serves as a metamaterial emitter having the property of being able to emit heat mainly in the form of infrared rays. This property is considered to be due to a resonance phenomenon explained as magnetic polariton. Magnetic polariton is a resonance phenomenon in which a strong confinement effect of electromagnetic field emerges in a dielectric (dielectric layer 103) lying between two upper and lower conductors (the second conductor layer 102 and the first conductor layer 101). Thus, infrared emission sources in the thermal emission structure 100 with a high temperature are those portions of the dielectric layer 103 which are sandwiched between the first conductor layer 101 and the separate conductor layers of the second conductor layer 102 and those portions of the conductor layers which are in contact with the dielectric layer. Infrared rays from the emission sources are emitted in the form of plane waves to the surrounding environment. For this thermal emission structure 100, the resonance wavelength can be controlled by adjusting the material of the second conductor layer 102, the dielectric layer 103, or the first conductor layer 101 or adjusting the shape or periodic geometry of the second conductor layer 102. Thus, the thermal emission structure 100 exhibits such characteristics that the emittance of the emission surface is high at particular wavelengths.

Next, a description is given of the situation where the temperature of the thermal emission structure 100 is low, namely where the thermal emission structure 100 has a temperature (335 K, for example) lower than the Phase-transition temperature of vanadium dioxide. When the temperature of the thermal emission structure 100 is low, the second conductor layer 102 composed of vanadium dioxide assumes an insulator-like nature and exhibits a considerably lower electrical conductivity in its low-temperature phase than in its high-temperature phase. Thus, the thermal emission structure 100 does not serve as a metamaterial emitter as described above, and no resonance phenomenon occurs. Consequently, the thermal emittance of the thermal emission structure 100 at a low temperature is lower than the thermal emittance of the thermal emission structure 100 at a high temperature. The thermal emittance of the thermal emission structure 100 at a low temperature is lower than the thermal emittance of vanadium dioxide in the low-temperature phase because the presence of the first conductor layer (metal layer) allows reflection of thermal radiation from the substrate side and therefore reduction of penetration of the radiation to the second conductor layer side.

For the above reasons, the thermal emission structure according to the exemplary embodiment has heat release characteristics reverse to those of the Phase-change material used therein.

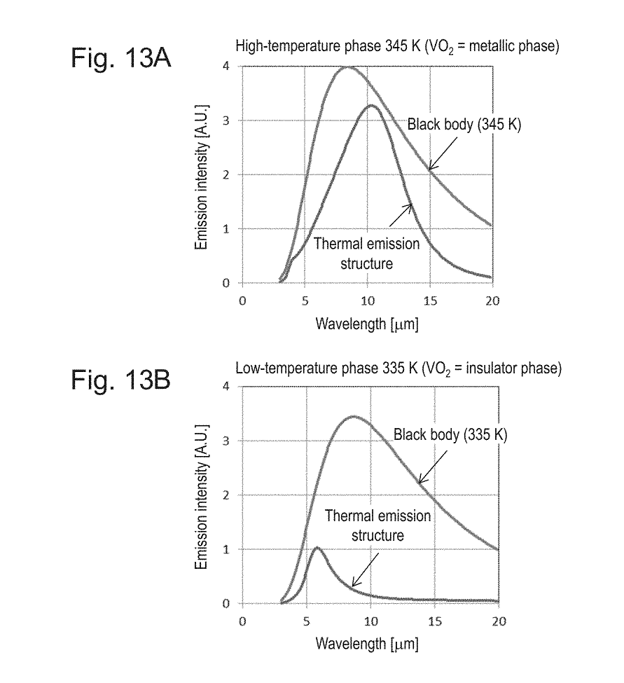

FIGS. 13A and 13B shows the result of simulation conducted in Example 1 for the emission characteristics of the thermal emission structure 100. FIG. 13A shows the result of measurement of the emission characteristics of the thermal emission structure 100 at a high temperature (345 K), while FIG. 13B shows the result of measurement of the emission characteristics of the thermal emission structure 100 at a low temperature (335 K). As shown in FIGS. 13A and 13B, the emission characteristics of the thermal emission structure 100 are such that the thermal emittance is high at a high temperature and low at a low temperature. The characteristics are different from the emission characteristics of vanadium dioxide which is used as the Phase-change material for the second conductor layer 102 (such emission characteristics that the thermal emittance is low in the high-temperature phase and high in the low-temperature phase). This result demonstrates that heat release characteristics reverse to those of the Phase-change material used in the thermal emission structure 100 can be achieved by the configuration of the thermal emission structure 100.

In the thermal emission structure according to the exemplary embodiment, the first conductor layer 101 (metal, for example) can reflect thermal radiation from the substrate side to prevent penetration of thermal radiation to the second conductor layer side, leading to a high contrast of the radiance. From the viewpoint of more effective reflection of thermal radiation from the substrate side, the first conductor layer 101 is a plain film in some embodiments.

The thermal emission structure 100 as described above can be formed, for example, as follows.

First, the first conductor layer 101 is formed by sputtering on the surface of a support substrate (not illustrated). An adhesive layer may be provided between the support substrate and first conductor layer 101. The support substrate may be, for example, a portion of an object whose temperature is to be controlled. The support substrate may alternatively be, for example, a portion of a heater for heating by thermal emission. The structure including the support substrate may be used as a thermal control device or thermal emission device according to the exemplary embodiments.

Next, the dielectric layer 103 is formed by atomic layer deposition (ALD) on the surface of the first conductor layer 101. Subsequently, a predefined resist pattern is formed on the surface of the dielectric layer 103, and then the second conductor layer 102 is formed by sputtering. The resist pattern is removed to complete the second conductor layer 102 (the separate conductor layers).

Alternatively, the thermal emission structure 100 may be produced by performing sputtering to form a laminate of the first conductor layer 101, the dielectric layer 103, and the second conductor layer 102 on the surface of a support substrate (Si substrate), then by forming a predefined resist pattern on the second conductor layer 102, and then by performing reactive ion etching to pattern the second conductor layer 102.

### Embodiment 2

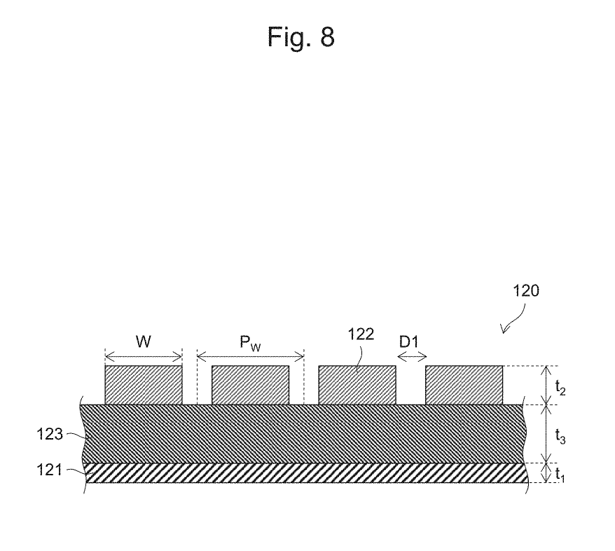

For Embodiment 2, a description is given with reference to FIG. 8.

Embodiment 2 relates to a thermal emission structure 120 in which the first conductor layer is composed of a Phase-change material (material that has a higher electrical conductivity in a high-temperature phase than in a low-temperature phase and that has a lower thermal emittance in the high-temperature phase than in the low-temperature phase) and the second conductor layer is composed of a non-Phase-change material. Namely, in FIG. 8, the thermal emission structure 120 includes a dielectric layer 123 a first conductor layer 121 that is composed of a Phase-change material (vanadium dioxide, for example) and a second conductor layer 122 that is composed of a non-Phase-change material.

It should be understood that with the thermal emission structure 120, the same effect as described in Embodiment 1 (namely, the effect of achieving heat release characteristics reverse to those of the used Phase-change material by the configuration of the thermal emission structure) can be obtained for the same reason as stated for Embodiment 1. In the thermal emission structure according to this exemplary embodiment, the Phase-change material is buried; thus, the thermal emission structure is expected to exhibit its characteristics more stably in long-term use.

### Embodiment 3

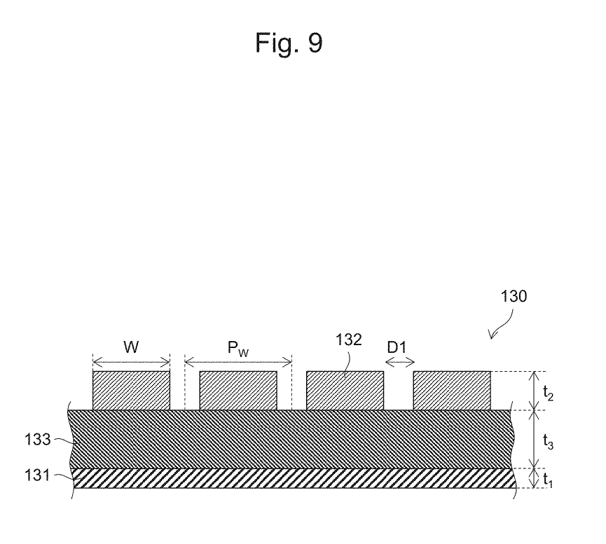

For Embodiment 3, a description is given with reference to FIG. 9.

Embodiment 3 relates to a thermal emission structure 130 in which both the first conductor layer and the second conductor layer are composed of a Phase-change material (material that has a higher electrical conductivity in a high-temperature phase than in a low-temperature phase and that has a lower thermal emittance in the high-temperature phase than in the low-temperature phase). Namely, in FIG. 9, the thermal emission structure 130 includes a dielectric layer 133, and a first conductor layer 131 and the second conductor layer 132 both of which are composed of a Phase-change material (vanadium dioxide, for example). In addition, fewer types of materials are used in the thermal emission structure according to this exemplary embodiment, and the thermal emission structure can thus be produced more easily.

It should be understood that with the thermal emission structure 130, the same effect as described in Embodiment 1 (namely, the effect of achieving heat release characteristics reverse to those of the used Phase-change material by the configuration of the thermal emission structure) can be obtained for the same reason as stated for Embodiment 1.

### Embodiment 4

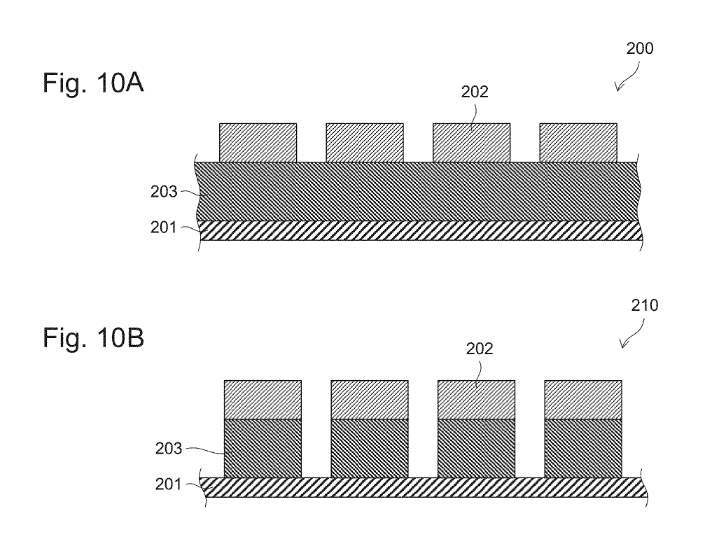

For Embodiment 4, a description is given with reference to FIGS. 10A and 10B.

In Embodiment 4, a thermal emission structure 200 is described in which a first conductor layer 201 is composed of a conductive material (non-Phase-change material: metal) which is not a Phase-change material and a second conductor layer 202 is composed of a Phase-change material (perovskite Mn oxide which is a material that has a lower electrical conductivity in a high-temperature phase than in a low-temperature phase and that has a higher thermal emittance in the high-temperature phase than in the low-temperature phase). FIG. 10A shows a dielectric layer in the shape of a flat plate; however, the dielectric layer 203 may have a periodic geometry conforming to the periodic geometry of the second conductor layer 202 as in a thermal emission structure 210 shown in FIG. 10B.

First, a description is given of the situation where the temperature of the thermal emission structure 200 is low, namely where the thermal emission structure has a temperature (200 K, for example) lower than the Phase-transition temperature of perovskite Mn oxide. As stated above, the thermal emission structure 200 comprises the second conductor layer 202 (Phase-change material: perovskite Mn oxide) having a periodic geometry, the first conductor layer 201 (Al, for example), and the dielectric layer 203 (amorphous silicon, for example) sandwiched between the second conductor layer 202 and the first conductor layer 201. When the temperature of the thermal emission structure 200 is low, the second conductor layer 202 composed of perovskite Mn oxide exhibits an electrical conduction property, which means that the thermal emission structure 200 has a configuration in which a dielectric layer is sandwiched between two conductor layers. Thus, the thermal emission structure 200 serves as a metamaterial emitter having the property of being able to emit heat mainly in the form of infrared rays. In this case, the infrared emission sources in the thermal emission structure 200 with a low temperature are those portions of the dielectric layer 203 which are sandwiched between the first conductor layer 201 and the separate conductor layers. Infrared rays from the emission sources are emitted in the form of plane waves to the surrounding environment.

Next, a description is given of the situation where the temperature of the thermal emission structure is high, namely where the thermal emission structure has a temperature (300 K, for example) higher than the Phase-transition temperature of perovskite Mn oxide. When the temperature of the thermal emission structure 200 is high, the second conductor layer 202 composed of perovskite Mn oxide assumes an insulator-like nature and exhibits a considerably lower electrical conductivity in its high-temperature phase than in its low-temperature phase. Thus, the thermal emission structure 200 does not serve as a metamaterial emitter as described above, and no resonance phenomenon occurs. Consequently, the thermal emittance of the thermal emission structure 200 at a high temperature is lower than the thermal emittance of the thermal emission structure 200 at a low temperature.

For the above reasons, the emission characteristics of the thermal emission structure 200 are such that the thermal emittance is low at a high temperature and high at a low temperature. The characteristics are different from the emission characteristics of perovskite Mn oxide which is used as the Phase-change material for the second conductor layer 202 (such emission characteristics that the thermal emittance is high in the high-temperature phase and low in the low-temperature phase). Thus, heat release characteristics reverse to those of the Phase-change material used in the thermal emission structure 200 can be achieved by the configuration of the thermal emission structure 200.

### Embodiment 5

Embodiment 5 relates to a thermal emission structure (not illustrated) in which the first conductor layer is composed of a Phase-change material (material that has a lower electrical conductivity in a high-temperature phase than in a low-temperature phase and that has a higher thermal emittance in the high-temperature phase than in the low-temperature phase) and the second conductor layer is composed of a non-Phase-change material. It should be understood that with this thermal emission structure, the same effect as described in Embodiment 4 (namely, the effect of achieving heat release characteristics reverse to those of the used Phase-change material by the configuration of the thermal emission structure) can be obtained for the same reason as stated for Embodiment 4.

### Embodiment 6

Embodiment 6 relates to a thermal emission structure (not illustrated) in which both the first conductor layer and the second conductor layer are composed of a Phase-change material (material that has a lower electrical conductivity in a high-temperature phase than in a low-temperature phase and that has a higher thermal emittance in the high-temperature phase than in the low-temperature phase). It should be understood that with this thermal emission structure, the same effect as described in Embodiment 4 (namely, the effect of achieving heat release characteristics reverse to those of the used Phase-change material by the configuration of the thermal emission structure) can be obtained for the same reason as stated for Embodiment 4.

### Embodiment 7: Heater

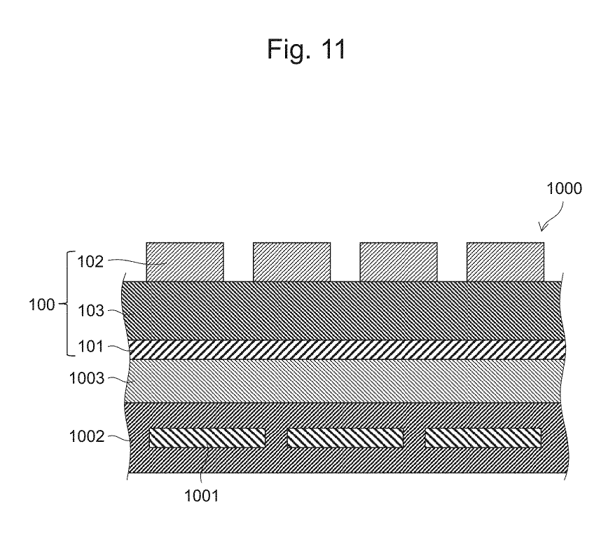

Next, an embodiment employing the thermal emission structure 100 according to Embodiment 1 as a thermal emission device in a heater (in particular, an infrared heater) for heating by thermal emission will be described with reference to FIG. 11.

FIG. 11 is a schematic cross-sectional view for illustrating the configuration of an infrared heater 1000 according to the exemplary embodiment. The infrared heater 1000 comprises a heater body, the thermal emission structure 100, and a casing (not illustrated). The thermal emission structure 100 serves as a thermal emission device that emits heat generated in a heat generator 1001. This infrared heater 1000 can emit infrared rays of particular wavelengths toward an unillustrated object disposed above the infrared heater 1000.

The heater body is configured as a so-called planar heater and comprises the heat generator 1001 that generates heat and a protective member 1002 that is an insulator being in contact with the heat generator 1001 and covering the periphery of the heat generator 1001. The heat generator 1001 can be, for example, in a zig-zag shape. Examples of the material of the heat generator 1001 include, but are not limited to, W, Mo, Ta, Fe—Cr—Al alloy, and Ni—Cr alloy. Examples of the protective member 1002 include insulating resins such as polyimide and ceramics. The heater body is disposed inside the casing. Both ends of the heat generator 1001 are respectively connected to a pair of input terminals (not illustrated) attached to the casing. Electrical power is externally supplied to the heat generator 1001 through the pair of input terminals. The heater body may be a planar heater having a configuration in which a ribbon-shaped heat generator is wound around an insulator. The outer shape of the planar heater can be designed as appropriate depending on, for example, the shape of the object to be heated and may be, for example, rectangular or circular.

A support substrate 1003 is disposed on the protective member 1002. The thermal emission structure 100 is disposed on the support substrate 1003. An adhesive layer may be provided between the support substrate 1003 and the first conductor layer.

The support substrate 1003 can be joined to the first conductor layer 101 via an adhesive layer. The support substrate 1003 is secured inside the casing with the aid of a fixing means (not illustrated) and supports the thermal emission structure 100. Examples of the material of the support substrate 1003 include materials such as Si and glass which allow easy formation of a smooth surface, have high heat resistance, and are resistant to thermal warping. The support substrate 1003 and the heater body need not be in contact and may be separated by a space in the up-down direction.

Examples of the form of the casing include an approximately rectangular parallelepiped casing having an interior space and an open bottom. The heater body and the thermal emission structure 100 can be disposed in the internal space of the casing. The casing may be made of a metal (SUS or aluminum, for example) so as to reflect infrared rays emitted from the heat generator 1001.

Heat generated in the heat generator 1001 is transmitted to the thermal emission structure 100, for example, through thermal conduction, and infrared rays in a particular wavelength range (infrared rays in a wavelength range around the maximum peak) can be selectively emitted from the emission surface of the thermal emission structure 100 to the object to be heated. Thus, an object having relatively high infrared absorbance in the wavelength range around the maximum peak can, for example, be efficiently heated by the infrared emission.

Heaters are desired to reach an operation temperature as quickly as possible at the start-up. The thermal emission structure according to the exemplary embodiments has the advantage of being able to limit thermal radiation during temperature rise (at low temperatures) and thereby complete the temperature rise quickly.

### Embodiment 8: Thermal Control Device

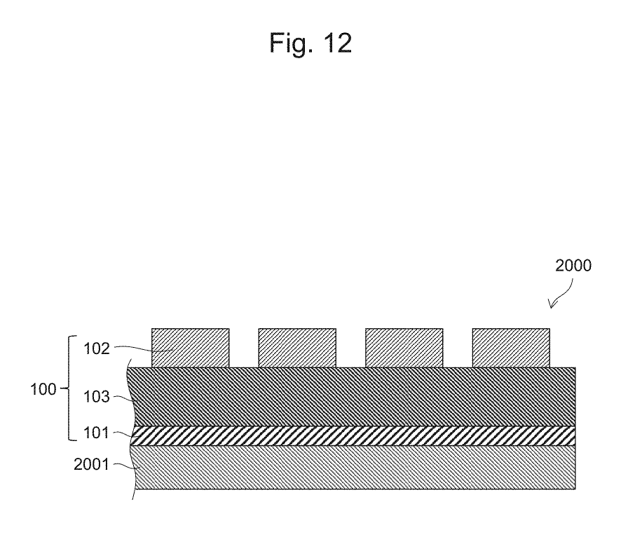

Next, an embodiment employing the thermal emission structure 100 according to Embodiment 1 as a thermal control device capable of controlling heat (in particular, the temperature) of an object will be described with reference to FIG. 12.

FIG. 12 is a schematic cross-sectional view showing thermal control system 2000 in which the thermal emission structure 100 serving as a thermal control device is disposed on an object 2001 whose heat is to be controlled.

As seen from the foregoing description, when the object 2001 has a low temperature, the thermal emittance of the thermal emission structure 100 disposed on the object 2001 is low because of the heat release characteristics of the thermal emission structure 100, and thus the amount of heat released from the object 2001 to the outside environment can be reduced. Consequently, the decrease in temperature of the object 2001 can be reduced. On the other hand, when the object 2001 has a high temperature, the thermal emittance of the thermal emission structure 100 is high, so that the amount of heat released from the object 2001 to the outside environment can be increased. Consequently, the increase in temperature of the object 2001 can be reduced. Examples of the object include, but are not limited to, electronic equipment.

The thermal control device according to the exemplary embodiment may be disposed inside or outside the object. In view of the fact that the thermal control device according to the exemplary embodiment releases heat by thermal emission, in some embodiments, the thermal control device may be disposed outside the object and in some other embodiments, the thermal control device may be disposed on the object.

The thermal control device according to the exemplary embodiment may comprise another component in addition to the thermal emission structure and may, for example, comprise the support substrate described above.

The exemplary embodiments can be also construed to relate to a thermal control system comprising an object and the thermal emission structure of this disclosure that serves as a thermal control device for controlling heat of the object. Additionally, the exemplary embodiments can be also construed to relate to a method of controlling heat of an object by providing the thermal emission structure of this disclosure inside or outside the object.

It should be appreciated that the exemplary embodiments are not limited in any way to the embodiments described above, and other various embodiments can be implemented within the technical scope of the exemplary embodiments.

### Examples

The following describes the exemplary embodiments with reference to the Examples. However, the scope of the exemplary embodiments is not limited by the Examples presented below.

### Example 1: Inspection 1 Using Simulation

To inspect the emission characteristics of the thermal emission structure 100 of Embodiment 1 described above (see FIG. 7A), the thermal emission structure 100 was analyzed using an electromagnetic simulator (the name of the software: CST MICROWAVE STUDIO 2016).

As for the components of the thermal emission structure 100 analyzed, aluminum (Al) was used as the first conductor layer 101, vanadium dioxide (VO₂) was used as the second conductor layer 102, and amorphous silicon was used as the dielectric layer 103. The substrate was a Si substrate.

The dimensions of the components of the thermal emission structure 100 analyzed are shown in Table 1. The length L (size in the front-back direction) and the lengthwise pitch P_{L} (pitch in the front-back direction) were set equal to the width W (size in the right-left direction) and the widthwise pitch P_{W} (pitch in the right-left direction), respectively.

TABLE 1

| | Size (μm) |
|---|---|
| P_{W} | 1.20 |
| W | 0.95 |
| t₁ | 0.10 |
| t₂ | 0.20 |
| t₃ | 0.30 |

For the dielectric constants of the materials constituting the thermal emission structure 100 analyzed, definitional equations shown in Table 2 were referenced.

TABLE 2

| | Definitional equation | Parameter |
|---|---|---|
| Al | $ϵ ( ω ) = 1 - \frac{{ω}_{p}^{2}}{{ω}^{2} + 1 ωγ}$ | ω = Angular frequency ωₚ = 3570 × 10¹² × 2 × π γ = 19.26 × 10¹² × 2 × π |
| Vanadium | Nonpatent literature 1* | Nonpatent literature 1* |
| dioxide | | |
| Amorphous | ϵ = ϵ′ + iϵ″ | ϵ′ = 13 |
| silicon | | ϵ″ = 1 |

*K. Ito, K. Nishikawa, H. Iizuka, H. Toshiyoshi, “Experimental investigation of radiative thermal rectifier using vanadium dioxide,” Applied Physics Letters 105, No. 25, 253503 (2014).

FIGS. 13A and 13B shows the simulation results. FIG. 13A shows the result of analysis conducted for the emission characteristics of the thermal emission structure 100 using a dielectric constant determined by assuming that the second conductor layer 102 (vanadium dioxide) is in a high-temperature phase (345 K). FIG. 13B shows the result of analysis conducted for the emission characteristics of the thermal emission structure 100 using a dielectric constant determined by assuming that the second conductor layer 102 (vanadium dioxide) is in a low-temperature phase (335 K). For reference, black-body spectra at the respective temperatures are also shown in FIGS. 13A and 13B. FIG. 13 reveals that the thermal emittance of the thermal emission structure 100 at the low temperature is lower than the thermal emittance of the thermal emission structure 100 at the high temperature.

FIGS. 13A and 13B also reveals that the thermal emission structure 100 resonates most strongly at a wavelength of about 10 As previously described, the resonance wavelength can be adjusted depending on the intended purpose.

### Example 2: Inspection 2 Using Simulation

The emission characteristics were inspected for the thermal emission structure 110 described above (an embodiment in which the dielectric layer has a periodic geometry so as to conform to the first conductor layer; see FIG. 7B)) in the same manner as in Example 1.

As for the components of the thermal emission structure 110 analyzed, aluminum (Al) was used as the first conductor layer 101, vanadium dioxide (VO₂) was used as the second conductor layer 102, and amorphous silicon was used as the dielectric layer 103 as in Example 1. The substrate was a Si substrate. The dimensions of the components of the thermal emission structure 110 were also set in the same manner as in Example 1 (see Table 1). The length L, width W, lengthwise pitch P_{L}, and widthwise pitch P_{W} of the dielectric layer 103 are equal to those of the second conductor layer since the dielectric layer 103 conforms to the first conductor layer. For the dielectric constants of the materials constituting the thermal emission structure 110, the definitional equations shown in Table 2 were referenced as in Example 1.

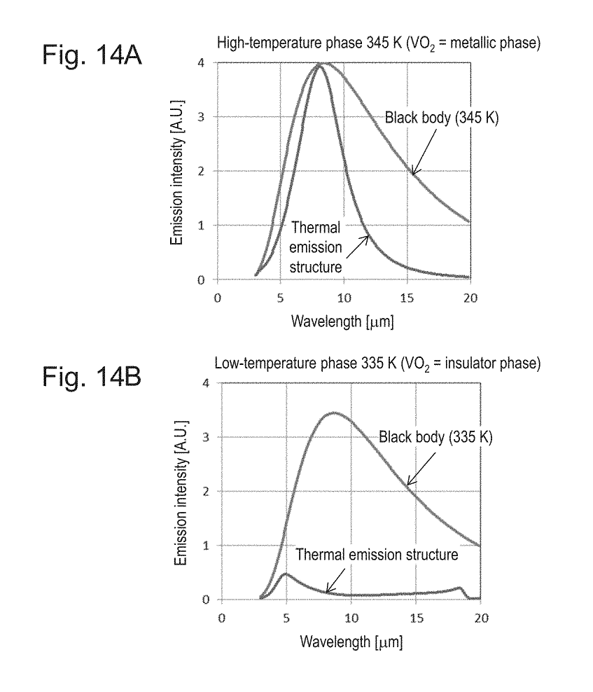

FIGS. 14A and 14B shows the simulation results. FIG. 14A shows the result of analysis conducted for the emission characteristics of the thermal emission structure 110 using a dielectric constant determined by assuming that the second conductor layer 102 (vanadium dioxide) is in a high-temperature phase (345 K). FIG. 14B shows the result of analysis conducted for the emission characteristics of the thermal emission structure 110 using a dielectric constant determined by assuming that the second conductor layer 102 (vanadium dioxide) is in a low-temperature phase (335 K). For reference, black-body spectra at the respective temperatures are also shown in FIGS. 14A and 14B. FIG. 14 reveals that the thermal emittance of the thermal emission structure 110 at the low temperature is lower than the thermal emittance of the thermal emission structure 110 at the high temperature.

### Example 3: Inspection 3 Using Simulation

To inspect the emission characteristics of the thermal emission structure 120 of Embodiment 2 described above (see FIG. 8), the thermal emission structure 120 was analyzed using an electromagnetic simulator (the name of the software: CST MICROWAVE STUDIO 2016).

As for the components of the thermal emission structure 120 analyzed, vanadium dioxide (VO₂) was used as the first conductor layer 121, tungsten (W) was used as the second conductor layer 122, and amorphous silicon was used as the dielectric layer 123. The substrate was a Si substrate.

The dimensions of the components of the thermal emission structure 120 analyzed are shown in Table 3. The length L (size in the front-back direction) and the lengthwise pitch P_{L} (pitch in the front-back direction) were set equal to the width W (size in the right-left direction) and the widthwise pitch P_{W} (pitch in the right-left direction), respectively.

TABLE 3

| | Size (μm) |
|---|---|
| P_{W} | 0.60 |
| W | 0.50 |
| t₁ | 0.10 |
| t₂ | 0.10 |
| t₃ | 0.30 |

For the dielectric constants of vanadium dioxide and amorphous silicon, the definitional equations shown in Table 2 were referenced as in Example 1. Referenced for the dielectric constant of tungsten was “W (Tungsten)”, “Ordal et al. 1988: n, k 0.667-200 μm” in RefractiveIndex.INFO Refractive index database” (https://refractiveindex.info/).

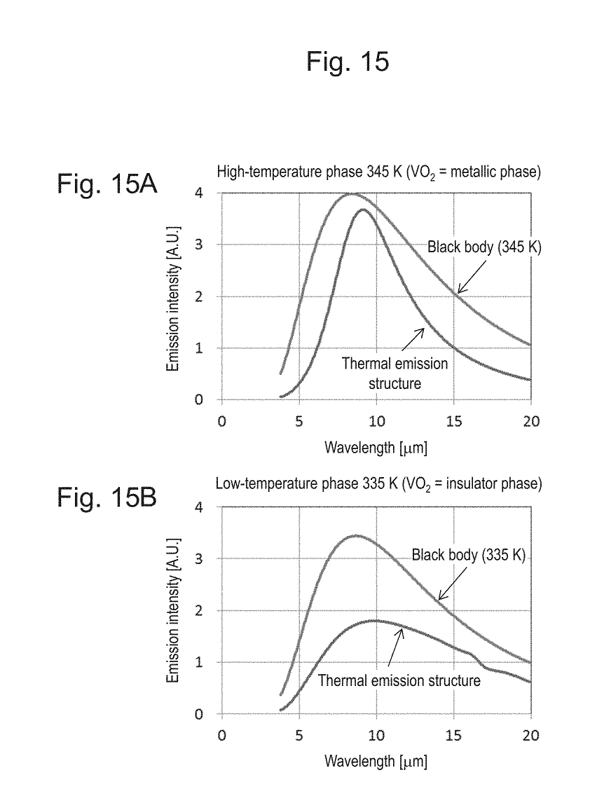

FIGS. 15A and 15B shows the simulation results. FIG. 15A shows the result of analysis conducted for the emission characteristics of the thermal emission structure 120 using a dielectric constant determined by assuming that the first conductor layer 121 (vanadium dioxide) is in a high-temperature phase (345 K). FIG. 15B shows the result of analysis conducted for the emission characteristics of the thermal emission structure 120 using a dielectric constant determined by assuming that the first conductor layer 121 (vanadium dioxide) is in a low-temperature phase (335 K). For reference, black-body spectra at the respective temperatures are also shown in FIGS. 15A and 15B. FIGS. 15A and 15B reveals that the thermal emittance of the thermal emission structure 120 at the low temperature is lower than the thermal emittance of the thermal emission structure 120 at the high temperature.

### Example 4: Inspection 4 Using Simulation

To inspect the emission characteristics of the thermal emission structure 100 described above, simulation was conducted in the same manner as in Example 1, except for using tungsten instead of aluminum as the first conductor layer 101 and setting the dimensions shown in Table 4 for the components.

TABLE 4

| | Size (μm) |
|---|---|
| P_{W} | 1.35 |
| W | 0.65 |
| t₁ | 0.10 |
| t₂ | 0.20 |
| t₃ | 0.35 |

As in Example 1, the length L (size in the front-back direction) and the lengthwise pitch P_{L} (pitch in the front-back direction) were set equal to the width W (size in the right-left direction) and the widthwise pitch P_{W} (pitch in the right-left direction), respectively.

For the dielectric constants of vanadium dioxide and amorphous silicon, the definitional equations shown in Table 2 were referenced as in Example 1. Referenced for the dielectric constant of tungsten was “W (Tungsten)”, “Ordal et al. 1988: n, k 0.667-200 μm” in RefractiveIndex.INFO Refractive index database” (https://refractiveindex.info/).

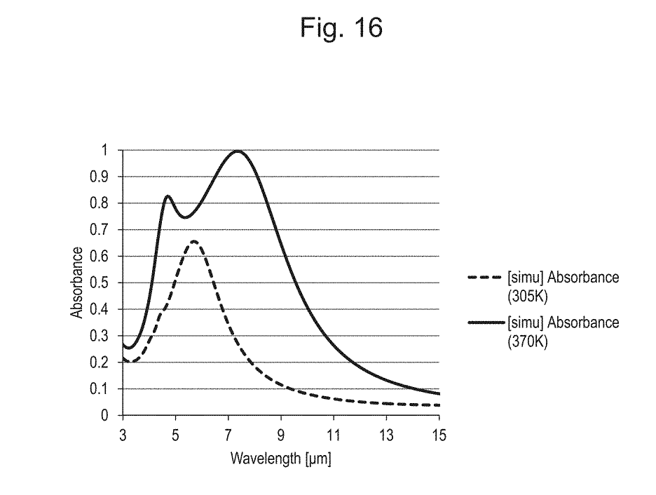

FIG. 16 shows the simulation results. FIG. 16 shows the result of analysis conducted for the emission characteristics of the thermal emission structure 100 using a dielectric constant determined by assuming that the second conductor layer 102 (vanadium dioxide) is in a high-temperature phase (370 K) and the result of analysis conducted for the emission characteristics of the thermal emission structure 100 using a dielectric constant determined by assuming that the second conductor layer 102 (vanadium dioxide) is in a low-temperature phase (305 K). FIG. 16 reveals that the thermal emittance of the thermal emission structure 100 at the low temperature is lower than the thermal emittance of the thermal emission structure 100 at the high temperature.

### Example 5

According to the following procedures, the thermal emission structure 100 inspected by simulation in Example 4 was actually produced.

First, tungsten (W) was disposed as the first conductor layer 101 on the surface of a support substrate (Si substrate) by sputtering. Next, amorphous silicon was disposed as the dielectric layer 103 on the surface of the first conductor layer 101 by sputtering. Subsequently, vanadium dioxide was disposed as the second conductor layer 102 on the surface of the dielectric layer 103 by sputtering. A predefined resist pattern was then formed, and reactive ion etching was performed to produce the thermal emission structure 100.

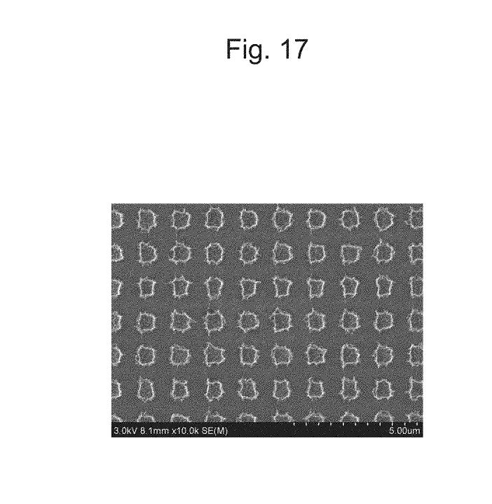

FIG. 17 shows a SEM image of the thermal emission structure 100 thus produced. As shown by the SEM image of FIG. 17, vanadium dioxide disposed as the second conductor layer 102 is patterned to have a periodic geometry.

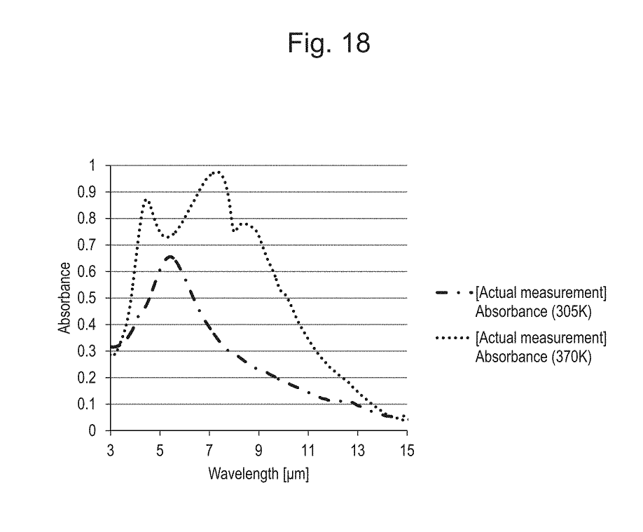

For the thermal emission structure 100 produced, absorption spectra at temperatures of 305 K and 370 K were measured using an infrared spectrophotometer (manufactured by Thermo Fisher Scientific Inc. under the product name “Nicolet is50”). It should be understood from the Kirchhoff's law that the absorbance and emittance (radiance) are equal. The absorption spectra obtained are shown in FIG. 18. FIG. 18 reveals that the thermal emittance of the thermal emission structure 100 at the low temperature is lower than the thermal emittance of the thermal emission structure 100 at the high temperature.

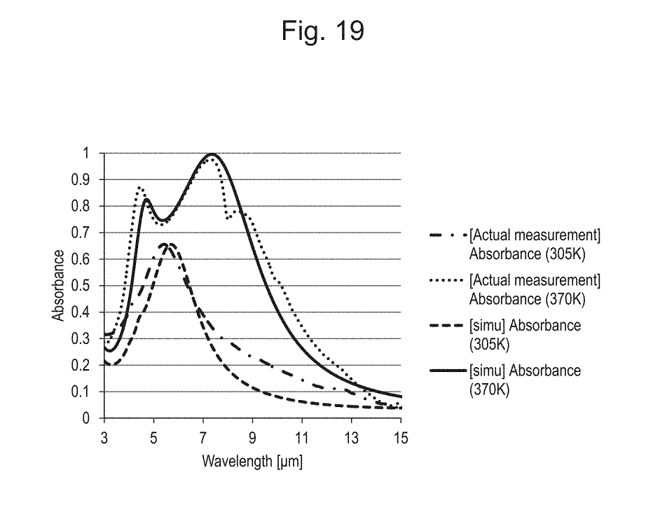

FIG. 19 shows both the absorption spectra shown in FIG. 16 which were obtained by simulation and the absorption spectra shown in FIG. 18 which were obtained for the actually produced thermal emission structure 100. As shown in FIG. 19, it was observed that the simulation results agree approximately with the actual measurement results.

### Example 6: Inspection 5 Using Simulation

To inspect the emission characteristics of the thermal emission structure 100 described above, simulation was conducted in the same manner as in Example 1, except for using tungsten as the first conductor layer 101, using alumina (Al₂O₃) instead of amorphous silicon as the dielectric layer 103, and setting the dimensions shown in Table 4 for the components.

TABLE 5

| | Size (μm) |
|---|---|
| P_{W} | 3.10 |
| W | 2.40 |
| t₁ | 0.10 |
| t₂ | 0.10 |
| t₃ | 0.30 |

As in Example 1, the length L (size in the front-back direction) and the lengthwise pitch P_{L} (pitch in the front-back direction) were set equal to the width W (size in the right-left direction) and the widthwise pitch P_{W} (pitch in the right-left direction), respectively.

For the dielectric constant of vanadium dioxide, the definitional equations shown in Table 2 were referenced as in Example 1. Referenced for the dielectric constant of tungsten was “W (Tungsten)”, “Ordal et al. 1988: n, k 0.667-200 μm” in RefractiveIndex.INFO—Refractive index database” (https://refractiveindex.info/). As the dielectric constant of alumina, a refractive index measured by spectroscopic ellipsometry (with infrared variable angle spectroscopic ellipsometer IR-VASE manufactured by J.A. Woollam Co. Inc.) was used.

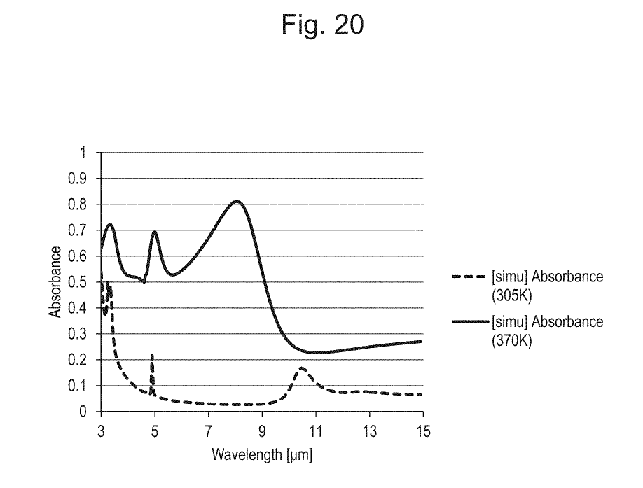

FIG. 20 shows the simulation results (absorption spectra). FIG. 20 shows the result of analysis conducted for the emission characteristics of the thermal emission structure 100 using a dielectric constant determined by assuming that the second conductor layer 102 (vanadium dioxide) is in a high-temperature phase (370 K) and the result of analysis conducted for the emission characteristics of the thermal emission structure 100 using a dielectric constant determined by assuming that the second conductor layer 102 (vanadium dioxide) is in a low-temperature phase (305 K). FIG. 20 reveals that the thermal emittance of the thermal emission structure 100 at the low temperature is lower than the thermal emittance of the thermal emission structure 100 at the high temperature.

### Example 7

According to the following procedures, the thermal emission structure 100 inspected by simulation in Example 6 was actually produced.

First, tungsten (W) was disposed as the first conductor layer 101 on the surface of a support substrate (Si substrate) by sputtering. Next, alumina was disposed as the dielectric layer 103 on the surface of the first conductor layer 101 by sputtering. Subsequently, vanadium dioxide was disposed as the second conductor layer 102 on the surface of the dielectric layer 103 by sputtering. A predefined resist pattern was then formed, and reactive ion etching was performed to produce the thermal emission structure 100.

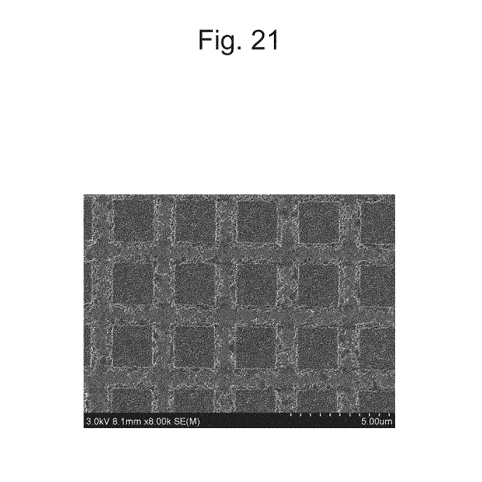

FIG. 21 shows a SEM image of the thermal emission structure 100 thus produced. As shown by the SEM image of FIG. 21, vanadium dioxide disposed as the second conductor layer 102 is patterned to have a periodic geometry.

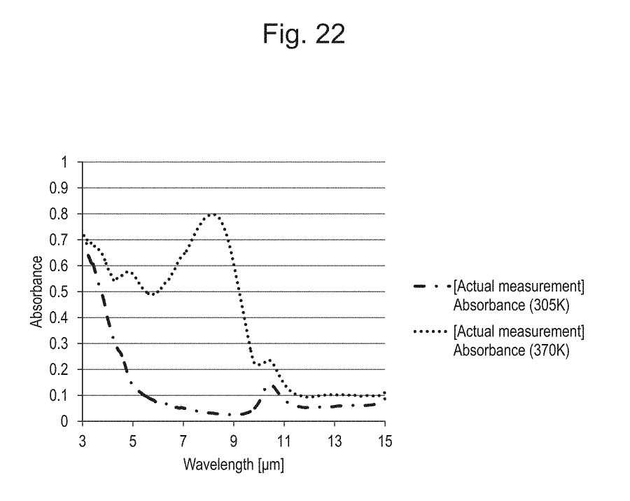

For the thermal emission structure 100 produced, absorption spectra at temperatures of 305 K and 370 K were measured using an infrared spectrophotometer (manufactured by Thermo Fisher Scientific Inc. under the product name “Nicolet is50”). The absorption spectra obtained are shown in FIG. 22. FIG. 22 reveals that the thermal emittance of the thermal emission structure 100 at the low temperature is lower than the thermal emittance of the thermal emission structure 100 at the high temperature.

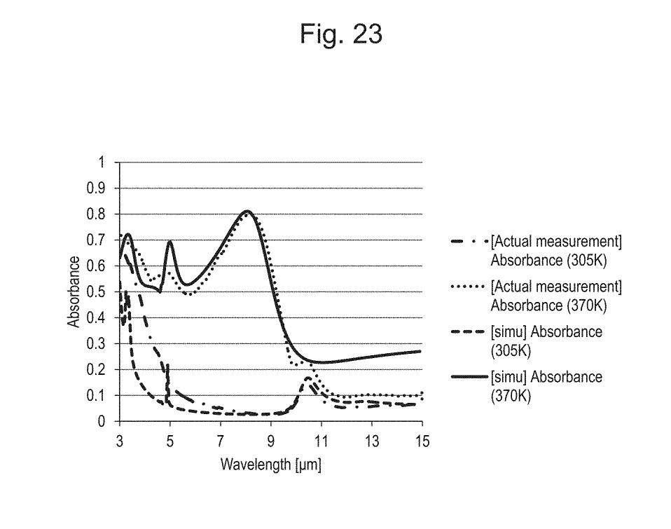

FIG. 23 shows both the absorption spectra shown in FIG. 20 which were obtained by simulation and the absorption spectra shown in FIG. 22 which were obtained for the actually produced thermal emission structure 100. As shown in FIG. 23, it was observed that the simulation result agrees approximately with the actual measurement result.

Although the foregoing has described the exemplary embodiments in detail, the specific configurations are not limited to the exemplary embodiments. Design modifications made without departing from the gist of the exemplary embodiments are intended to be embraced herein.

What is claimed is:

1. A thermal emission structure capable of thermal emission, comprising:
a first conductor layer;
a dielectric layer on the first conductor layer; and
a second conductor layer on the dielectric layer and having a periodic geometry,
wherein at least one of the first conductor layer and the second conductor layer comprises a Phase-change material having an electrical conduction property that varies between a high-temperature phase and a low-temperature phase.

2. The thermal emission structure according to claim 1, wherein the first conductor layer comprises a non-Phase-change material, and the second conductor layer comprises the Phase-change material.

3. The thermal emission structure according to claim 1, wherein the first conductor layer comprises the Phase-change material, and the second conductor layer comprises a non-Phase-change material.

4. The thermal emission structure according to claim 1, wherein both the first conductor layer and the second conductor layer comprise the Phase-change material.

5. The thermal emission structure according to claim 1, wherein the Phase-change material is a material that has a higher electrical conductivity in the high-temperature phase than in the low-temperature phase and that has a lower thermal emittance in the high-temperature phase than in the low-temperature phase.

6. The thermal emission structure according to claim 5, wherein the Phase-change material is a vanadium oxide.

7. The thermal emission structure according to claim 1, wherein the Phase-change material is a material that has a lower electrical conductivity in a high-temperature phase than in a low-temperature phase and that has a higher thermal emittance in the high-temperature phase than in the low-temperature phase.

8. The thermal emission structure according to claim 7, wherein the Phase-change material is a perovskite Mn oxide.

9. The thermal emission structure according to claim 1, having a thermal emittance that varies according to temperature.

10. A heater comprising a heat generator that generates heat and the thermal emission structure according to claim 1 that serves as a thermal emission device that emits the heat.

11. A thermal control system comprising an object and the thermal emission structure according to claim 1 that serves as a thermal control device that controls heat of the object.

12. A method of controlling heat of an object by providing the thermal emission structure according to claim 1 inside or outside the object.
